(19) United States
(12) Patent Application Publication
(10) Pub. No.: US 2026/0141753 A1
(43) Pub. Date: May 21, 2026

(54) Hydraulic Safety Manager

(71) Applicant: Right Testing Labs, Atlanta, GA (US)

(72) Inventors: Stephen Scott Parkhurst, College Park, GA (US); Carl Thomas Archbold, San Diego, CA (US); Bruce Hastedt, Forest Park, GA (US); Drew Matthew Mersereau, College Park, GA (US)

(73) Assignee: Right Testing Labs, Atlanta, GA (US)

(21) Appl. No.: 19/385,808

(22) Filed: Nov. 11, 2025

Related U.S. Application Data
(60) Provisional application No. 63/720,914, filed on Nov. 15, 2024.

(51) Int. Cl. G07C 5/02; B60T 17/22; F02D 41/22; G07C 5/08

(52) U.S. Cl. CPC G07C 5/02; B60T 17/222; F02D 41/22; G07C 5/0825; F02D 2041/228

(57) ABSTRACT

A hydraulic safety manager is described. The hydraulic safety manager may be able to measure hydraulic pressure and ensure sufficient hydraulic capability before allowing operation of an associated vehicle. If a minimum pressure is not detected at the hydraulic system, a vehicle lock-out feature may be enabled (or not disabled) such that activation of the vehicle is not enabled or allowed (and/or other actions may be performed, such as generation of warnings or activation of fail-safe measures).

### CROSS-REFERENCE TO RELATED APPLICATIONS

This application claims priority to U.S. Provisional Patent Application Ser. No. 63/720,914, filed on Nov. 15, 2024.

### BACKGROUND OF THE INVENTION

Many vehicles may utilize hydraulic components for safety-critical systems, such as braking systems.

Thus there is a need for ways to monitor hydraulic performance and respond to any issues.

### BRIEF DESCRIPTION OF THE DRAWINGS

The novel features of the disclosure are set forth in the appended claims. However, for purposes of explanation, several embodiments are illustrated in the following drawings.

FIG. 1 illustrates an example overview of one or more embodiments described herein, in which a hydraulic safety interface is implemented;

FIG. 2 illustrates a flow chart of an exemplary process that provides hydraulic safety initialization, monitoring, and response; and

FIG. 3 illustrates a flow chart of an exemplary process that provides hydraulic safety monitoring and fail-safe response;

FIG. 4 illustrates a flow chart of an exemplary process that generates warnings associated with hydraulic safety; and

FIG. 5 illustrates a schematic block diagram of one or more exemplary devices used to implement various embodiments.

### DETAILED DESCRIPTION OF THE INVENTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide a hydraulic safety manager that is able to measure hydraulic pressure and ensure sufficient hydraulic capability before allowing operation of an associated vehicle. If a minimum pressure is not detected at the hydraulic system, a vehicle lock-out feature may be enabled (or not disabled) such that activation of the vehicle is not enabled or allowed (and/or other actions may be performed, such as generation of warnings or activation of fail-safe measures).

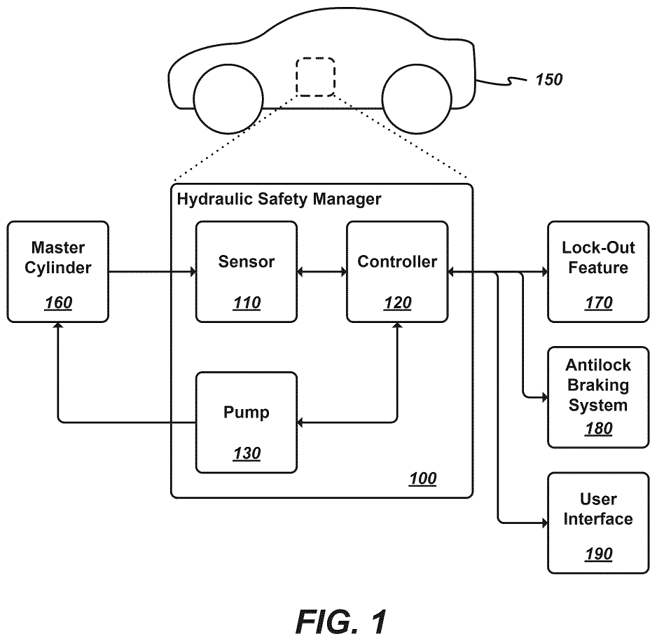

FIG. 1 illustrates an example overview of one or more embodiments described herein, in which a hydraulic safety manager 100 is implemented. As shown, the hydraulic safety manager 100 may include, utilize, and/or otherwise be associated with one or more sensors 110, a controller 120, and a pump 130. The hydraulic safety manager 100 may be included in, utilized by, and/or otherwise associated with a vehicle 150 having a hydraulic brake system (not shown). In this example, hydraulic safety manager 100 may interact with various modules, components, systems, and/or other elements of vehicle 150, such as a master cylinder 160, a lock-out feature 170, an antilock brake system 180, and a user interface 190.

Vehicle 150 may be a car, truck, motorcycle, bus, bicycle, and/or other vehicle that may utilize hydraulic brake systems. Vehicle 150 may include various electronic and/or mechanical components that may be associated with various communication and/or control interfaces. Hydraulic safety manager 100 may be able to communicate with, and/or direct operations of, such components of vehicle 150. For instance, hydraulic safety manager 100 may be able to receive sensor data from vehicle 150. As another example, hydraulic safety manager 100 may be able to enable or disable a lock-out feature 170 associated with vehicle 150.

Master cylinder 160 may be a component or system associated with vehicle 150. Master cylinder 160 may convert foot pressure (e.g., at a brake pedal) into hydraulic pressure (e.g., to be utilized by a brake or clutch system of the vehicle 150).

Lock-out feature 170 may be, include, utilize, and/or otherwise interact with various components and/or systems associated with vehicle 150. Lock-out feature 170 may include, utilize, and/or otherwise be associated with components such as switches, controllers, communication interfaces, etc. In some embodiments, lock-out feature 170 may be associated with a relay (not shown) or similar component that may be able to selectively enable or disable the activation and/or operation of a vehicle 150 by opening or closing a circuit associated with the vehicle 150 (e.g., an ignition system of the vehicle 150). Such a relay may be at least partly controlled by the hydraulic safety manager 100. In some embodiments, lock-out feature 170 may include a communication interface that may interact with vehicle 150, for example by disabling or enabling an ignition system.

Antilock brake system 180 may be associated with vehicle 150. Hydraulic safety manager 100 may be able to interact with antilock brake system 180, such as by receiving sensor or other data (e.g., master cylinder pressure, brake pedal force, etc.) and/or at least partly controlling the operations of the antilock brake system 180. Antilock brake system 180 may include a control module, various sensors (e.g., wheel speed sensors), a master cylinder (such as master cylinder 160), a modulator unit, gear pulsers, and/or other appropriate components.

User interface 190 may be a component or system associated with vehicle 150 (e.g., a vehicle head unit). User interface 190 may include various input/output elements such as, for instance, a display screen (e.g., a touchscreen), audio outputs (e.g., speakers), audio inputs (e.g., a microphone), buttons or keypads, touchpads, switches, knobs, etc. Hydraulic safety manager 100 may be able to interact with user interface 190, such as by receiving user inputs (e.g., via a touchscreen, keypad, microphone, etc.), and/or providing outputs to the user (e.g., via speakers, display screen, haptic feedback, etc.). As one example, hydraulic safety manager 100 may utilize user interface 190 to provide a warning to a driver that hydraulic pressure is below a specified threshold. As another example, hydraulic safety manager 100 may utilize user interface 190 to provide instructions to a driver that may rectify low hydraulic pressure (e.g., by directing the driver to press on the brake pedal for a specified duration).

Sensor 110 may include and/or utilize various electrical and/or mechanical components that may be able to sense relevant attributes of vehicle 150. Sensor 110 may be able to sense hydraulic pressure at master cylinder 160. In some embodiments, sensor 110 may be a component of vehicle 150 (e.g., a sub-component of antilock brake system 180) and hydraulic safety manager 100 may receive sensed data via a communication interface. In some embodiments, multiple sensors 110 may be distributed throughout various locations or elements associated with vehicle 150. For instance, a first sensor 110 may measure pressure at the master cylinder 160, a second sensor 110 may measure brake pedal pressure, a third sensor 110 may measure pressure at a different location along the hydraulic circuit (e.g., pressure at one or more brake calipers or wheel cylinders or at various hydraulic lines or reservoirs utilized by the hydraulic system).

Controller 120 may be, include, and/or utilize components such as microcontrollers, microprocessors, digital signal processors, etc. Controller 120 may be implemented via a device such as device #9900 described below. Controller 120 may be able to send data to, and/or receive data from, various other elements, such as sensor 110, pump 130, vehicle 150, master cylinder 160, lock-out feature 170, antilock brake system 180, user interface 190, and/or other appropriate elements. Controller 120 may be able to receive sensor data from vehicle 150 (e.g., speed, location, acceleration, brake pressure, etc.). Controller 120 may be able to execute instructions. Controller 120 may be able to at least partly direct the operations of various other elements or components, such as sensor 110, pump 130, vehicle 150, master cylinder 160, lock-out feature 170, antilock brake system 180, user interface 190, and/or other appropriate elements.

Pump 130 may be a hydraulic pump capable of moving hydraulic fluid (and/or other fluids) throughout a system such as antilock braking system 180 in order to increase or decrease hydraulic pressure. In this example, pump 130 may be utilized to automatically increase pressure at the master cylinder 160 when the pressure measured by a resource such as sensor 110 is less than a specified threshold.

In some embodiments, pump 130 may be associated with one or more reservoirs or tanks (not shown). For example, a reservoir may house hydraulic fluid that may be utilized by the pump 130. As another example, a reservoir may house a stop-leak substance that may be utilized by the pump 130. In some embodiments, multiple pumps 130 (and/or a pump with multiple inlets and/or outlets) may be utilized with various components in addition to, or in place of, the master cylinder 160. For instance, each wheel cylinder or set of brake calipers may be associated with a pump 130 (or additional outlet or inlet).

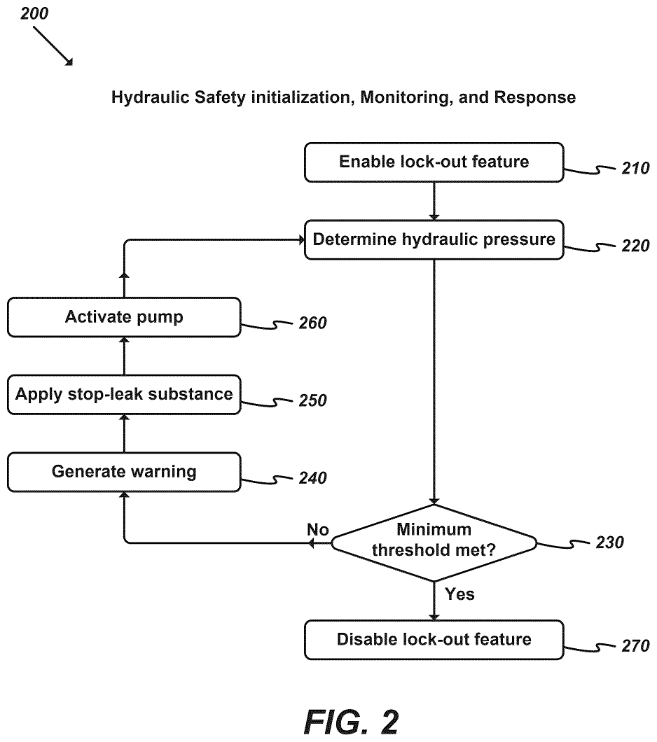

FIG. 2 illustrates an example process 200 for providing hydraulic safety initialization, monitoring, and response in some embodiments. The hydraulic safety feature may determine whether a hydraulic brake system is working properly, whether to issue a warning or other feedback, and/or whether to take action to resolve any malfunctions. The process 200 may be performed whenever an associated vehicle is powered on, and/or other under other appropriate conditions. In some embodiments, process 200 may be performed by hydraulic safety manager 100.

As shown, process 200 may include enabling (at 210) a lock-out feature, such as lock-out feature 170. The lock-out feature 170 may be enabled, for example, by opening a relay, by communicating to an ignition system of vehicle 150 (e.g., by sending a “disable ignition” message to a controller associated with vehicle 150), and/or other appropriate ways.

As shown, process 200 may include determining (at 220) hydraulic pressure. Hydraulic pressure may be measured via a resource such as sensor 110, and the measured pressure may be received by hydraulic safety manager 100. The hydraulic pressure may be measured at (or near) an element such as the master cylinder 160 (and/or other appropriate components associated with the hydraulic brake system).

The process 200 may include determining (at 230) whether a minimum threshold (and/or some other specified criteria) has been met. The hydraulic brake manager 100 may be associated with a minimum specified pressure threshold (and/or other type of sensor measurement, such as reservoir levels). The threshold may be set or determined in various appropriate ways. For instance, the threshold may be based on a default value, user-entered value, and/or other appropriate data. For example, a look-up table or other resource available to the hydraulic brake manager 100 may include a listing of vehicles (e.g., by make, model, trim, etc.) and/or components, and a listing of associated minimum threshold values.

If process 200 determines (at 230) that the minimum threshold has not been met, process 200 may include generating (at 240) a warning. The warning may be provided via a resource such as user interface 190 (e.g., via an audio warning such as a repeating tone, via a visual warning such as a blinking light or other indicator, via haptic feedback, and/or via other appropriate resources or features).

In some cases, the “warning” may include instructions and/or other feedback for a user. For example, a user may be instructed to apply force to a brake pedal for a specified duration (e.g., five to sixty seconds) before the pressure is measured and evaluated again.

Warning generation will be described in more detail below in reference to process 400.

The process 200 may include applying (at 250) a stop-leak substance. Depending on the amount of pressure, and/or any other criteria, a stop-leak substance may be applied, for example, by opening a valve associated with a reservoir or other storage, and providing the stop-leak substance to a pump, such as pump 130.

Process 200 may include activating (at 260) a pump, such as pump 130. If a pump or other such resource is available, the process 200 may activate the pump 130 to increase the pressure at the master cylinder and/or other component(s). As described above, the pump 130 may be able to transport hydraulic fluid, stop-leak substances, and/or other fluids, as appropriate.

Process 200 may repeat operations 220-260 until the process 200 determines (at 230) that the minimum threshold has been met.

If the process 200 determines (at 230) that the minimum threshold has been met, the process may include disabling (at 270) the lock-out feature 170. For example, in some embodiments a relay or similar element may be closed (allowing an ignition circuit, for example, to operate) only when the minimum threshold has been met, where if the relay remains open the lock-out feature 170 may remain deactivated. As another example, an “enable ignition” message may be sent to a controller associated with vehicle 150.

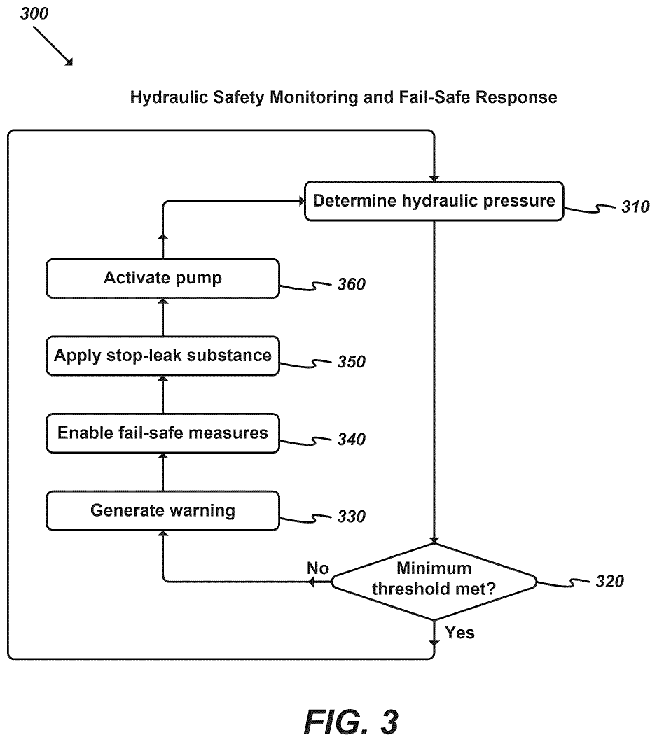

FIG. 3 illustrates an example process 300 for providing hydraulic safety monitoring and fail-safe response. The process 300 may be performed during vehicle operation (e.g., after ignition, while in motion, etc.). In some embodiments, process 300 may be performed by hydraulic safety manager 100.

As shown, process 300 may include determining (at 310) hydraulic pressure. Such a determination may be made in a similar manner to that described above in reference to operation 220.

The process 300 may include determining (at 320) whether a minimum threshold pressure has been met. Such a determination may be made in a similar manner to that described above in reference to operation 230.

If process 300 determines (at 320) that the minimum threshold has not been met, process 200 may include generating (at 230) a warning. The warning may be generated in a similar manner to that described above in reference to operation 240. In this case, the warning may include indications or instructions related to capabilities or performance, potential driver actions, etc. For example, a warning may indicate that brake performance may be degraded or that pressure applied to the brake pedal may need to be increased. As another example, a warning may indicate actions such as directing a user to a runaway truck ramp.

Process 300 may include enabling (at 340) fail-safe measures. Such fail-safe measures may depend on the capabilities of vehicle 150. For example, a parking brake or other such system may be enabled or applied in order to replace or supplement the performance of a primary braking system. As another example, one or more messages may be sent to a controller associated with vehicle 150 such that the transmission is instructed to apply engine braking by downshifting. As still another example, a horn or similar component may be activated to warn others of a potential threat.

Process 300 may include applying (at 350) a stop-leak substance. Such a stop-leak substance may be applied in a similar manner to that described above in reference to operation 250.

The process 300 may include activating (at 360) a pump. Such a pump may be activated in a similar manner as described above in reference to operation 260.

Process 300 may repeat operations 310-360 until the process 300 determines (at 320) that the minimum threshold pressure has been met.

If the process 300 determines (at 330) that the minimum threshold pressure has been met, the process may return to operation 310 and the process may repeat while the vehicle is operated.

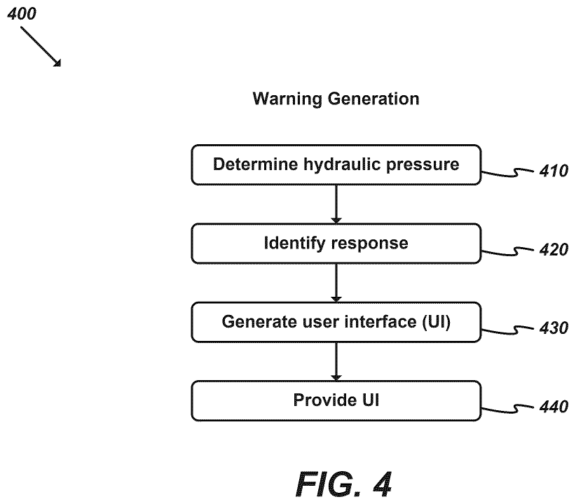

FIG. 4 illustrates an example process 400 for generating warnings associated with hydraulic safety. The process 400 may be utilized to generate warnings, provide UI features, and/or otherwise respond to issues. The process 400 may be performed whenever a warning is generated, such as at operation 240 or operation 330 described above. In some embodiments, process 400 may be performed by hydraulic safety manager 100.

As shown, process 400 may include determining (at 410) hydraulic pressure. Such a determination may be made in a similar manner to that described above in reference to operation 220.

Process 400 may include identifying (at 420) a response. Such a response may be identified based on various relevant criteria, algorithms, etc. For example, hydraulic safety manager 100 may maintain a library of potential responses and matching criteria associated with each response. Matching criteria may include, for instance, measured pressure level, site of measured pressure, capabilities of the vehicle 150, user preferences, and/or other relevant criteria (e.g., any other type of sensor data available, such as speed, location, acceleration, etc.). Each response may indicate various sets of actions, refer to templates or other UI elements, and/or include information relevant to the response. For example, if a pressure is slightly less than a specified threshold, pump 130 may be activated and no other action taken if the specified threshold pressure is achieved. As another example, if pressure is significantly less than a specified threshold (or less than a second threshold), a stop-leak substance may be applied in addition to activating the pump 130. As still another example, if pressure is determined to be lower than a specified threshold while the associated vehicle 150 is in motion, an audio warning may be generated.

The process 400 may include generating (at 430) a UI based on the identified response. The UI may include or utilize various types of elements, as appropriate. For instance, a UI may include text-based or graphical components, audio elements, messages or other communications, etc. The UI may include information related to, for example, measured data, actions undertaken, instructions for the driver, feedback to a fleet manager or maintenance personnel, etc.

As shown, process 400 may include providing (at 440) the UI. The UI may be provided in various appropriate ways depending on various appropriate factors such as UI components available to vehicle 150, user preferences, type of warning or response, etc. For instance, a text-based or graphical warning may be provided via a display screen of vehicle 150. As another example, an audio warning may be provided via speakers of vehicle 150. As still another example, a text message may be generated and sent to a fleet manager. As yet another example, emergency personnel may be notified of the location, speed, heading, and/or other relevant information associated with an affected vehicle 150.

One of ordinary skill in the art will recognize that processes 200-400 may be implemented in various different ways without departing from the scope of the disclosure. For instance, the elements may be implemented in a different order than shown. As another example, some embodiments may include additional elements or omit various listed elements. Elements or sets of elements may be performed iteratively and/or based on satisfaction of some performance criteria. Non-dependent elements may be performed in parallel. Elements or sets of elements may be performed continuously and/or at regular intervals.

The processes and modules described above may be at least partially implemented as software processes that may be specified as one or more sets of instructions recorded on a non-transitory storage medium. These instructions may be executed by one or more computational element(s) (e.g., microprocessors, microcontrollers, digital signal processors (DSPs), application-specific integrated circuits (ASICs), field programmable gate arrays (FPGAs), other processors, etc.) that may be included in various appropriate devices in order to perform actions specified by the instructions.

As used herein, the terms “computer-readable medium” and “non-transitory storage medium” are entirely restricted to tangible, physical objects that store information in a form that is readable by electronic devices.

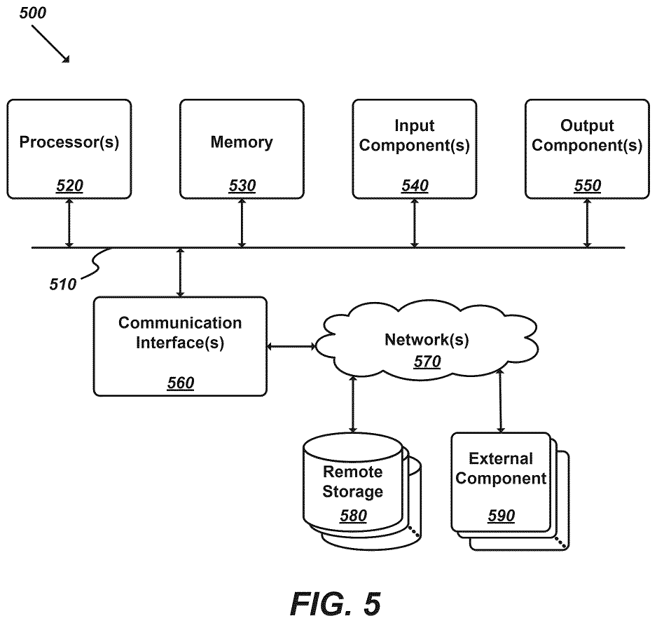

FIG. 5 illustrates a schematic block diagram of an exemplary device (or system or devices) 500 used to implement some embodiments. For example, the systems, devices, components, and/or operations described above in reference to FIG. 1 may be at least partially implemented using device 500. As another example, the processes described in reference to FIG. 2, FIG. 3, and FIG. 4 may be at least partially implemented using device 500.

Device 500 may be implemented using various appropriate elements and/or sub-devices. For instance, device 500 may be implemented using one or more personal computers (PCs), servers, mobile devices (e.g., smartphones), tablet devices, wearable devices, and/or any other appropriate devices. The various devices may work alone (e.g., device 500 may be implemented as a single smartphone) or in conjunction (e.g., some components of the device 500 may be provided by a mobile device while other components are provided by a server).

As shown, device 500 may include at least one communication bus 510, one or more processors 520, memory 530, input components 540, output components 550, and one or more communication interfaces 560.

Bus 510 may include various communication pathways that allow communication among the components of device 500. Processor 520 may include a processor, microprocessor, microcontroller, DSP, logic circuitry, and/or other appropriate processing components that may be able to interpret and execute instructions and/or otherwise manipulate data. Memory 530 may include dynamic and/or non-volatile memory structures and/or devices that may store data and/or instructions for use by other components of device 500. Such a memory device 530 may include space within a single physical memory device or spread across multiple physical memory devices.

Input components 540 may include elements that allow a user to communicate information to the computer system and/or manipulate various operations of the system. The input components may include keyboards, cursor control devices, audio input devices and/or video input devices, touchscreens, motion sensors, etc. Output components 550 may include displays, touchscreens, audio elements such as speakers, indicators such as light-emitting diodes (LEDs), printers, haptic or other sensory elements, etc. Some or all of the input and/or output components may be wirelessly or optically connected to the device 500.

Device 500 may include one or more communication interfaces 560 that are able to connect to one or more networks 570 or other communication pathways. For example, device 500 may be coupled to a web server on the Internet such that a web browser executing on device 500 may interact with the web server as a user interacts with an interface that operates in the web browser. Device 500 may be able to access one or more remote storages 580 and one or more external components 590 through the communication interface 560 and network 570. The communication interface(s) 560 may include one or more application programming interfaces (APIs) that may allow the device 500 to access remote systems and/or storages and also may allow remote systems and/or storages to access device 500 (or elements thereof).

It should be recognized by one of ordinary skill in the art that any or all of the components of computer system 500 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

Device 500 may perform various operations in response to processor 520 executing software instructions stored in a computer-readable medium, such as memory 530. Such operations may include manipulations of the output components 550 (e.g., display of information, haptic feedback, audio outputs, etc.), communication interface 560 (e.g., establishing a communication channel with another device or component, sending and/or receiving sets of messages, etc.), and/or other components of device 500.

The software instructions may be read into memory 530 from another computer-readable medium or from another device. The software instructions stored in memory 530 may cause processor 520 to perform processes described herein. Alternatively, hardwired circuitry and/or dedicated components (e.g., logic circuitry, ASICs, FPGAs, etc.) may be used in place of or in combination with software instructions to implement processes described herein. Thus, implementations described herein are not limited to any specific combination of hardware circuitry and software.

The actual software code or specialized control hardware used to implement an embodiment is not limiting of the embodiment. Thus, the operation and behavior of the embodiment has been described without reference to the specific software code, it being understood that software and control hardware may be implemented based on the description herein.

While certain connections or devices are shown, in practice additional, fewer, or different connections or devices may be used. Furthermore, while various devices and networks are shown separately, in practice the functionality of multiple devices may be provided by a single device or the functionality of one device may be provided by multiple devices. In addition, multiple instantiations of the illustrated networks may be included in a single network, or a particular network may include multiple networks. While some devices are shown as communicating with a network, some such devices may be incorporated, in whole or in part, as a part of the network.

Some implementations are described herein in conjunction with thresholds. To the extent that the term “greater than” (or similar terms) is used herein to describe a relationship of a value to a threshold, it is to be understood that the term “greater than or equal to” (or similar terms) could be similarly contemplated, even if not explicitly stated. Similarly, to the extent that the term “less than” (or similar terms) is used herein to describe a relationship of a value to a threshold, it is to be understood that the term “less than or equal to” (or similar terms) could be similarly contemplated, even if not explicitly stated. Further, the term “satisfying,” when used in relation to a threshold, may refer to “being greater than a threshold,” “being greater than or equal to a threshold,” “being less than a threshold,” “being less than or equal to a threshold,” or other similar terms, depending on the appropriate context.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

The foregoing relates to illustrative details of exemplary embodiments and modifications may be made without departing from the scope of the disclosure. Even though particular combinations of features are recited in the claims and/or disclosed in the specification, these combinations are not intended to limit the possible implementations of the disclosure. In fact, many of these features may be combined in ways not specifically recited in the claims and/or disclosed in the specification. For instance, although each dependent claim listed below may directly depend on only one other claim, the disclosure of the possible implementations includes each dependent claim in combination with every other claim in the claim set.

1. A device, comprising:
one or more processors configured to:
enable an ignition lock-out feature of a vehicle;
receive a hydraulic pressure measurement associated with a brake system of the vehicle; and
disable the ignition lock-out feature when the hydraulic pressure measurement is above a specified threshold.

2. The device of claim 1, the one or more processors further configured to activate a pump when the hydraulic pressure measurement is below the specified threshold.

3. The device of claim 1, the one or more processors further configured to apply a stop-leak substance when the hydraulic pressure measurement is below the specified threshold.

4. The device of claim 1, the one or more processors further configured to generate a warning when the hydraulic pressure measurement is below the specified threshold.

5. The device of claim 4, wherein generating the warning comprises providing a user interface via a display of the vehicle.

6. The device of claim 1, the one or more processors further configured to enable fail-safe measures when the hydraulic pressure measurement is below the specified threshold and the vehicle is in motion.

7. The device of claim 6, wherein the fail-safe measures comprise activating engine braking by downshifting.

8. A non-transitory computer-readable medium, storing a plurality of processor-executable instructions to:
enable an ignition lock-out feature of a vehicle;
receive a hydraulic pressure measurement associated with a brake system of the vehicle; and
disable the ignition lock-out feature when the hydraulic pressure measurement is above a specified threshold.

9. The non-transitory computer-readable medium of claim 8, the plurality of processor-executable instructions further to activate a pump when the hydraulic pressure measurement is below the specified threshold.

10. The non-transitory computer-readable medium of claim 8, the plurality of processor-executable instructions further to apply a stop-leak substance when the hydraulic pressure measurement is below the specified threshold.

11. The non-transitory computer-readable medium of claim 8, the plurality of processor-executable instructions further to generate a warning when the hydraulic pressure measurement is below the specified threshold.

12. The non-transitory computer-readable medium of claim 11, wherein generating the warning comprises providing a user interface via a display of the vehicle.

13. The non-transitory computer-readable medium of claim 8, the plurality of processor-executable instructions further to enable fail-safe measures when the hydraulic pressure measurement is below the specified threshold and the vehicle is in motion.

14. The non-transitory computer-readable medium of claim 13, wherein the fail-safe measures comprise activating engine braking by downshifting.

15. A method comprising:
enabling an ignition lock-out feature of a vehicle;
receiving a hydraulic pressure measurement associated with a brake system of the vehicle; and
disabling the ignition lock-out feature when the hydraulic pressure measurement is above a specified threshold.

16. The method of claim 15 further comprising activating a pump when the hydraulic pressure measurement is below the specified threshold.

17. The method of claim 15 further comprising applying a stop-leak substance when the hydraulic pressure measurement is below the specified threshold.

18. The method of claim 15 further comprising generating a warning when the hydraulic pressure measurement is below the specified threshold.

19. The method of claim 18, wherein generating the warning comprises providing a user interface via a display of the vehicle.

20. The method of claim 15 further comprising enabling fail-safe measures when the hydraulic pressure measurement is below the specified threshold and the vehicle is in motion, wherein the fail-safe measures comprise activating engine braking by downshifting.
